(19) United States
(12) Patent Application Publication
(10) Pub. No.: US 2019/0090627 A1
(43) Pub. Date: Mar. 28, 2019

(54) SIMPLE TABLE USABLE IN CONJUNCTION WITH POLYETHYLENE TEREPHTHALATE BOTTLES

(71) Applicant: ChaeHyun LIM, Seoul (KR)

(72) Inventor: ChaeHyun LIM, Seoul (KR)

(21) Appl. No.: 16/138,498

(22) Filed: Sep. 21, 2018

(30) Foreign Application Priority Data
Sep. 27, 2017 (KR) 20-2017-0005070

(51) Int. Cl. A47B 13/02

(52) U.S. Cl. CPC A47B 13/021; F16B 12/14

(57) ABSTRACT

Disclosed herein is a simple table usable in conjunction with PET bottles. The simple table includes: a table configured such that receiving depressions in which threads are formed on their inner circumferential surfaces are formed therein; and coupling parts configured such that threads corresponding to the threads of the receiving depressions are formed on the outer circumferential surfaces thereof and such that coupling holes in which threads corresponding threads on the outer circumferential surfaces of the mouth and neck portions of the PET bottles are formed on their inner circumferential surfaces are formed therein; wherein the coupling holes are formed to a depth larger than the heights of the mouth and neck portions of the PET bottles so that the heights of the PET bottles coupled to the table can be adjusted based on the insertion depths of the mouth and neck portions of the PET bottles.

### CROSS-REFERENCE TO RELATED APPLICATIONS

This application claims the benefit of Korean Application No. 20-2017-0005070, filed Sep. 27, 2017, in the Korean Intellectual Property Office. All disclosures of the document named above are incorporated herein by reference.

### BACKGROUND

### 1. Technical Field

The present invention relates to a simple table that can be used in conjunction with polyethylene terephthalate (PET) bottles.

### 2. Description of the Related Art

Recently, there have been many cases where a driver and passengers spend a lot of time in a vehicle, such as a case where people travel or move a long distance. In response to this trend, a simple table that is provided in a vehicle and used for studying or dining has been commercialized and has provided convenience to vehicle occupants.

Generally, such a simple table is coupled with a steering wheel or seat via a separate fastening structure and performs the above-described function, or is placed on the lap of a user and then used.

However, the above-described simple table is designed to be provided and used in a vehicle, and thus legs are not installed or accommodated on or in the table. Accordingly, a problem arises in that the usefulness of the table is degraded when it is used outside a vehicle.

Korean Utility Model Registration No. 20-0474000 (published on Aug. 13, 2014 and issued to Hong-woo Shin) discloses a simple table combinable with PET bottles, which enables PET bottles to be combined with a simple table in order to use the PET bottles as legs. This simple table eliminates the separate cost required when the legs of the table are broken and replaced.

However, although the above-described conventional technology has no problem when the legs of the table provided as PET bottles have the same length, a problem arises in that the function of the simple table cannot be performed when the differences between the lengths of the legs occur due to the differences in the type of PET bottles.

### SUMMARY

The present invention has been conceived to overcome the above-described problems, and an object of the present invention is to provide technology that provides a simple table usable in conjunction with PET bottles for the purpose of providing the simple table with legs and enables the simple table to perform its own function even when the lengths of the legs are different due to the differences between the standards of the PET bottles.

Objects of the present invention are not limited to the above-described object, but other objects that have not been described above will be clearly understood by those having ordinary knowledge in the art to which the present invention pertains from the following description.

According to an aspect of the present invention, there is provided a simple table usable in conjunction with PET bottles, the simple table including: a table configured such that receiving depressions in which threads are formed on their inner circumferential surfaces are formed therein; and coupling parts configured such that threads corresponding to the threads of the receiving depressions are formed on the outer circumferential surfaces thereof in order to enable the coupling parts to be screwed into the receiving depressions, and such that coupling holes in which threads corresponding threads on the outer circumferential surfaces of the mouth and neck portions of the PET bottles are formed on their inner circumferential surfaces are formed therein; wherein the coupling holes are formed to a depth larger than the heights of the mouth and neck portions of the PET bottles so that the heights of the PET bottles coupled to the table can be adjusted based on the insertion depths of the mouth and neck portions of the PET bottles.

The table may be formed such that the shape of the bottom surface thereof is formed in a curved shape corresponding to the shape of the lap of a user when it is placed and used on the lap of the user; and the coupling holes may be formed in respective protruding portions protruding in directions toward the user in the curved shape of the table.

The coupling parts may be configured such that the heights of the PET bottles screwed into the inner circumferential surfaces of the coupling parts are adjusted based on the heights of the coupling parts protruding from the table after the screw coupling of the coupling parts with the receiving depressions is released.

The simple table may further include rotating covers made of magnetic material, and configured to cover axial-direction ends of the coupling parts exposed from a bottom surface of the table by being fitted into the axial-direction ends of the coupling parts in axial directions and to cause the coupling parts to be screwed into or released from the table in response to an operation in which a user grips and rotates the rotating covers.

Cover accommodation depressions having shapes corresponding to the shapes of the top surfaces of the rotating covers may be formed into the bottom surface of the table, and may accommodate and store the rotating covers separated from the coupling parts when the PET bottles are screwed into the coupling parts and then used.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a simple table usable in conjunction with PET bottles according to an embodiment of the present invention;

FIG. 2 is an exploded perspective view showing a simple table usable in conjunction with PET bottles according to another embodiment of the present invention;

FIG. 3 is a perspective view showing the configurations of a coupling part and a rotating cover according to the other embodiment of the present invention;

FIG. 4 is a perspective view of the bottom surface of the simple table showing a configuration for storing rotating covers according to the other embodiment of the present invention; and

FIG. 5 is a view showing the process of adjusting the insertion depth of a PET bottle according to the other embodiment of the present invention.

### DETAILED DESCRIPTION

Embodiments of the present invention will be described in detail, but descriptions of well-known technical parts will be omitted or abridged for brevity of description.

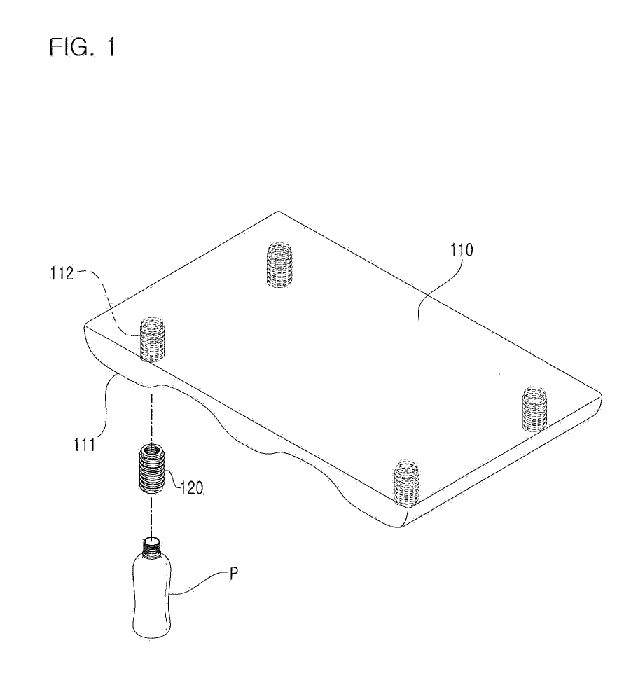

FIG. 1 is a perspective view showing a simple table 100 usable in conjunction with PET bottles P according to an embodiment of the present invention.

As shown in FIG. 1, the simple table 100 usable in conjunction with PET bottles P (hereinafter referred to as the “simple table”) according to the present embodiment allows a flat-plate table, which is provided and conveniently used in a vehicle, to be combined with the PET bottles P, which are readily available in a nearby place, for the purpose of providing the flat-plate table with legs, thereby enabling the combination to be used as a legged table. The simple table 100 includes a table 110 and coupling parts 120.

The table 110 refers to a support plate formed in a rectangular plate structure and configured such that objects can be placed on the top surface thereof, but is not limited thereto. The table 110 may be provided as a circular or polygonal support plate having a predetermined width.

In this case, depressed portions and protruding portions 111 corresponding to the shape of the lap of a user are formed on the bottom surface of the table 110 so that the simple table 100 can be used in close contact with the lap of the user when the simple table 100 is provided and used in a vehicle or when the simple table 100 is used without utilizing the PET bottles P as their legs. One or more receiving depressions 112 configured such that threads are formed on the inner circumferential surfaces thereof to thus enable the coupling parts 120 to be screwed thereinto are formed into the bottom surface of the table 110.

In this case, the receiving depressions 112 are preferably formed into the protruding portions 111 on the bottom surface of the table 110 to thus provide insertion depths for the mouth and neck portions of the PET bottles P.

The coupling parts 120 are inserted into the receiving depressions 112, and form insertion paths and fastening structures for the mouth and neck portions of the PET bottles P. Each of the coupling parts 120 is formed in a cylindrical structure in which a coupling hole 123 is formed in the lengthwise direction thereof. Threads 121 corresponding to threads formed on the inner circumferential surfaces of the receiving depressions 112 are formed on the outer circumferential surfaces of the coupling parts 120, and threads 122 corresponding to threads formed on the outer circumferential surfaces of the mouth and neck portions of the PET bottles P are formed on the inner circumferential surfaces of the coupling parts 120, thereby enabling the table 110 and the PET bottles P to be coupled to one another.

In this case, the coupling holes 123 of the coupling parts 120, which are the insertion paths of the PET bottles P, are formed to a depth larger than the heights of the mouth and neck portions of the PET bottles P. Accordingly, the differences between the heights of the PET bottles P attributable to the differences between various standards of the PET bottles P can be overcome via the insertion depths of the mouth and neck portions of the PET bottles P in the coupling holes 123, thereby enabling various PET bottles to be coupled with the table 110.

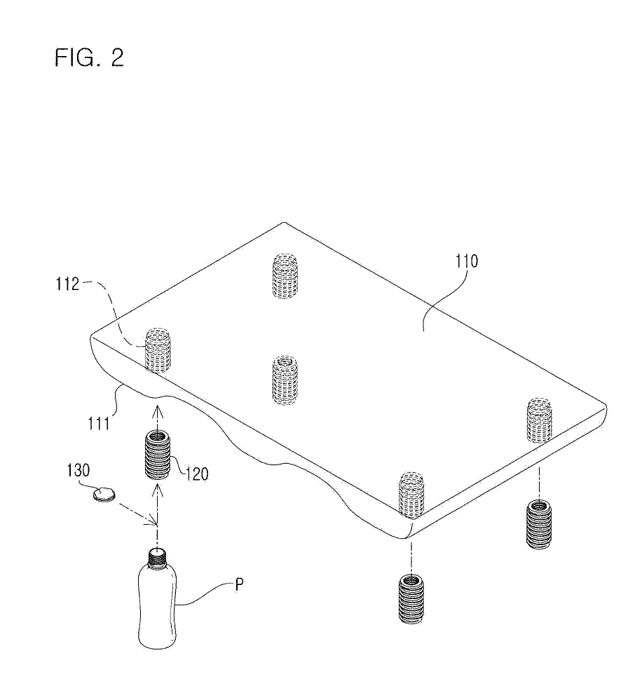

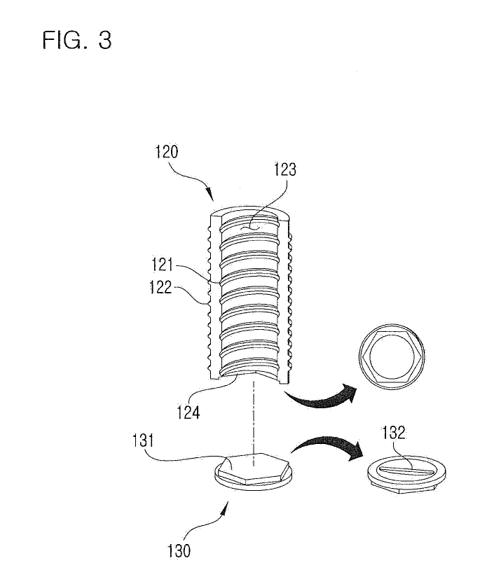

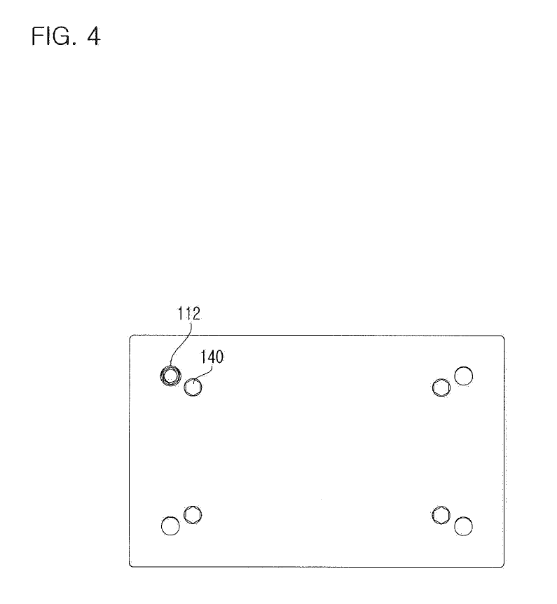

FIG. 2 is an exploded perspective view showing a simple table 100 usable in conjunction with PET bottles P according to another embodiment of the present invention, FIG. 3 is a perspective view showing the configurations of a coupling part and a rotating cover according to the other embodiment of the present invention, and FIG. 4 is a perspective view of the bottom surface of the simple table 100 showing a configuration for storing rotating covers according to the other embodiment of the present invention.

As shown in FIGS. 2 and 3, the simple table 100 according the present embodiment is configured such that the accommodation heights of the mouth and neck portions of PET bottles P can be adjusted in such a manner that coupling parts 120 protrude from a table 110 so that the coupling parts 120 can be coupled with the mouth and neck portions of the PET bottles P and function as gender changers in order to overcome the differences between the heights of the PET bottles P attributable to the various standards of the PET bottles P.

For this purpose, the simple table 100 according to the present embodiment includes the coupling parts 120 having respective cover receiving depressions 124, and rotating covers 130.

The cover receiving depressions 124 are formed in the shape of hexagonal receiving depressions along the edges of the ends of the coupling parts 120 in the lengthwise directions of the coupling parts 120, but are not limited thereto. It will be apparent that they may be formed in various polygonal shapes according to their purposes.

The rotating covers 130 are formed to have the same diameter as the outer circumferential surfaces of the coupling parts 120. The rotating covers 130 are made of magnetic material like the coupling parts 120. The rotating covers 130 cover ends of the coupling parts 120 exposed from the table 110 in the lengthwise direction of the coupling parts 120. Each of the rotating covers 130 includes a cover protrusion portion 131 formed in a hexagonal wrench head shape corresponding to the shape of each of the above-described cover receiving depressions 124 on the top surface of the rotating cover 130, and a cover grip portion 132 configured to receive rotating force attributable to the rotating manipulation of a user on the bottom surface of the rotating cover 130.

By using the rotating covers 130, a user may release the coupling parts 120 fastened to the table 110 and then cause the coupling parts 120 to protrude from the bottom surface of the table 110 to appropriate heights by rotating the cover grip portions 132 before inserting the mouth and neck portions of the PET bottles P into the coupling holes 123, and may then screw the PET bottles P into the coupling holes 123. Accordingly, the individual legs of the table having differences in height attributable to various standards of the PET bottles P can be adjusted to a uniform height.

In this case, as described above, when the rotating covers 130 cover the ends of the coupling parts 120 by means of magnetic force in order to prevent foreign materials from entering the coupling holes 123, the covering is preferably performed in such a manner that the rotating covers 130 are inserted such that they can be prevented from protruding from the bottom surface of the table 110, thereby improving the convenience of a user.

Referring to FIG. 4, the rotating covers 130 according to the present embodiment need to be separated when the mouth and neck portions of the PET bottles P are inserted into the coupling holes 123 and then used. Accordingly, cover accommodation depressions 140 may be further formed into the bottom surface of the table 110 by taking into account the carrying and loss of the rotating covers 130.

The cover accommodation depressions 140 may be provided as receiving depressions having the same shape as the top surfaces of the rotating covers 130 or ends of the coupling parts 120, and may be disposed to be gathered in inward radial directions. The reason for this is that a case where the rotating covers 130 selectively attached and detected via magnetic force are gathered and stored in the center portion of the table 110 can prevent the rotating covers 130 from being separated from the cover accommodation depressions 140 by external force more effectively than a case where the rotating covers 130 are separately stored in the outward radial directions of the table 110.

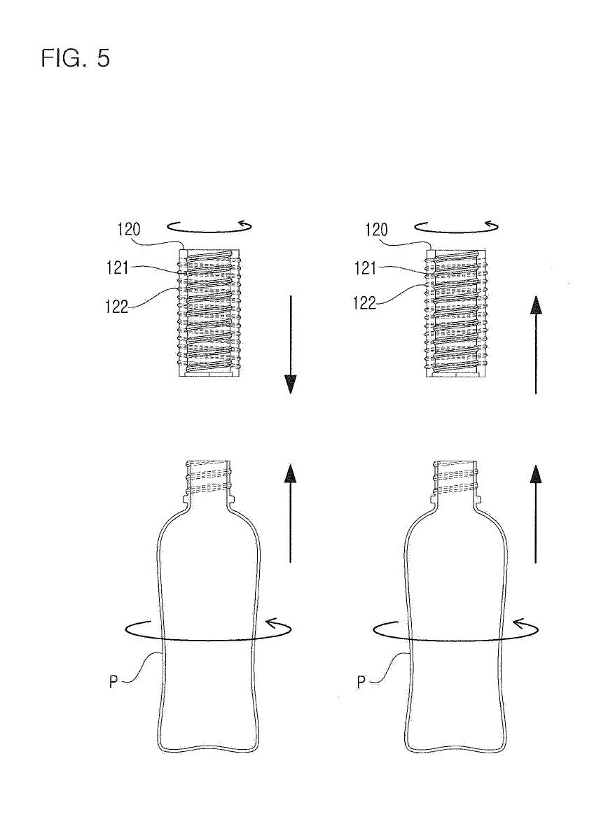

FIG. 5 is a view showing the process of adjusting the insertion depth of a PET bottle according to the other embodiment of the present invention.

As shown in FIG. 5, the simple table 100 according to the present embodiment enables the PET bottles P to be screwed into the table 110, thereby providing coupling force by means of a simple configuration and also enabling the minute adjustment of heights through screw rotation.

Although the insertion or protrusion heights of the coupling parts may be minutely adjusted by forming the threads 122 on the outer circumferential surfaces of the coupling parts 120 more densely than the threads 123 on the inner circumferential surfaces thereof and the PET bottles P and the coupling parts 120 may be prevented from being rotated together when the mouth and neck portions of the PET bottles P are inserted into the coupling holes 123 and then rotated by increasing the frictional force of the outer circumferential surfaces higher than that of the inner circumferential surfaces, the adjustment of the heights may be performed in different manners when the PET bottles P are inserted into and rotated in conjunction with the coupling parts 120.

More specifically, when the threads 121 on the inner circumferential surfaces of the coupling parts 120 and the threads 122 on the outer circumferential surfaces of the coupling parts 120 are formed in the same direction, the coupling parts 120 may be also screwed and inserted into the table 110 in response to the operation of coupling the PET bottles P through insertion. In contrast, when the threads 121 on the inner circumferential surfaces of the coupling parts 120 and the threads 122 on the outer circumferential surfaces of the coupling parts 120 are formed in symmetrical directions, the coupling parts 120 may be released and protrude from the table 110 in response to the operation of coupling the PET bottles P through insertion.

It will be apparent that in the above-described manners, the threads 121 and 122 may be formed in the same direction and the insertion depths of the PET bottles P in the table may be minutely adjusted and then used, or the threads 121 and 122 may be formed in symmetrical directions and the heights of the PET bottles P may be easily adjusted through the minute operation of a user.

As described above, according to the present invention, the following advantages are achieved.

First, the present invention is advantageous in that the legs of the table can be adjusted based on the screw coupling depths of the mouth and neck portions of PET bottles, so that the simple table can be conveniently used regardless of the standards of PET bottles.

Second, the present invention is advantageous in that the insertion depths of the coupling parts may be adjusted because the coupling parts are configured to be screwed into the table, so that the function of the simple table can be performed by overcoming the differences between the standards of PET bottles and using various PET bottles.

Effects of the present invention are not limited to the above-described effects, but other effects that have not been described above will be clearly understood by those having ordinary knowledge in the art to which the present invention pertains from the foregoing description.

Although the present invention has been specifically described in conjunction with the embodiments shown in the accompanying drawings, the above-described embodiments are intended merely to illustrate examples of the present invention. Accordingly, the present invention should not be construed as being limited only to the embodiments, but the scope of the present invention should be construed as encompassing not only the attached claims but also equivalents to the claims.

What is claimed is:

1. A simple table usable in conjunction with polyethylene terephthalate (PET) bottles, the simple table comprising:
a table configured such that receiving depressions in which threads are formed on their inner circumferential surfaces are formed therein; and
coupling parts configured such that threads corresponding to the threads of the receiving depressions are formed on outer circumferential surfaces thereof in order to enable the coupling parts to be screwed into the receiving depressions, and such that coupling holes in which threads corresponding threads on outer circumferential surfaces of mouth and neck portions of the PET bottles are formed on their inner circumferential surfaces are formed therein;
wherein the coupling holes are formed to a depth larger than heights of the mouth and neck portions of the PET bottles so that heights of the PET bottles coupled to the table can be adjusted based on insertion depths of the mouth and neck portions of the PET bottles.

2. The simple table of claim 1, wherein:
the table is formed such that a shape of a bottom surface thereof is formed in a curved shape corresponding to a shape of a lap of a user when it is placed and used on the lap of the user; and
the coupling holes are formed in respective protruding portions protruding in directions toward the user in the curved shape of the table.

3. The simple table of claim 1, wherein the coupling parts are configured such that the heights of the PET bottles screwed into the inner circumferential surfaces of the coupling parts are adjusted based on heights of the coupling parts protruding from the table after screw coupling of the coupling parts with the receiving depressions is released.

4. The simple table of claim 1, further comprising rotating covers made of magnetic material, and configured to cover axial-direction ends of the coupling parts exposed from a bottom surface of the table by being fitted into the axial-direction ends of the coupling parts in axial directions and to cause the coupling parts to be screwed into or released from the table in response to an operation in which a user grips and rotates the rotating covers.

5. The simple table of claim 4, wherein cover accommodation depressions having shapes corresponding to shapes of top surfaces of the rotating covers are formed into the bottom surface of the table, and accommodate and store the rotating covers separated from the coupling parts when the PET bottles are screwed into the coupling parts and then used.
